(19) United States
(12) Patent Application Publication
(10) Pub. No.: US 2015/0246376 A1
(43) Pub. Date: Sep. 3, 2015

(54) Method for Treating Oil Refinery Equipment for Pyrophoric Iron Sulfide Using Ozonated Water

(71) Applicant: Refined Technologies, Inc., Spring, TX (US)

(72) Inventor: Blake Montgomery, Spring, TX (US)

(21) Appl. No.: 14/636,522

(22) Filed: Mar. 3, 2015

Related U.S. Application Data
(60) Provisional application No. 61/947,088, filed on Mar. 3, 2014.

(51) Int. Cl. B08B 3/08

(52) U.S. Cl. CPC B08B 3/08

(57) ABSTRACT

Pyrophoric material such as iron sulfide is frequently found in refinery equipment. When the equipment is opened to the atmosphere for maintenance, an exothermic reaction may take place that can cause catastrophic damage. A process for treating pyrophoric material uses ozonated water to oxidize iron sulfide to iron oxide. The heat produced by this exothermic reaction is absorbed by the ozonated water.

### CROSS-REFERENCE TO RELATED APPLICATIONS

This application claims the benefit of U.S. Provisional Application No. 61/947,088 filed on Mar. 3, 2014.

### STATEMENT REGARDING FEDERALLY SPONSORED RESEARCH OR DEVELOPMENT

Not Applicable

### BACKGROUND OF THE INVENTION

1. Field of the Invention

The present invention generally relates to cleaning equipment in oil refineries and the like. More particularly, it relates to the oxidative deactivation of pyrophoric iron sulfide in such equipment.

2. Description of the Related Art Including Information Disclosed Under 37 CFR 1.97 and 1.98

A pyrophoric substance is generally defined as one that ignites spontaneously in air at or below 55° C. (130° F.). Examples include iron sulfide and many reactive metals including uranium (especially when powdered or thinly sliced).

Spontaneous ignition of iron sulfide either on the ground or inside equipment can occur in all refineries. If this occurs inside equipment such as columns, vessels, tanks and exchangers containing residual hydrocarbons and air, the resulting fire and possible explosion can be devastating.

Most commonly, pyrophoric iron fires occur during shutdowns when equipment and piping are opened for inspection or maintenance. Instances of fires in crude columns during turnarounds, explosions in sulfur, crude or asphalt storage tanks, overpressures in vessels, etc., due to pyrophoric iron ignition have been widely reported.

Iron sulfide is one such pyrophoric material that oxidizes exothermically when exposed to air. It can be found in solid iron sulfide scales in refinery units. These iron sulfide scales can be found in the form of pyrite, troilite, marcasite, or pyrrhotite, any of which will react in the presence of oxygen. These scales are formed by the conversion of iron oxide (rust) into iron sulfide in an oxygen-free atmosphere where hydrogen sulfide (H₂S) gas is present (or where the concentration of hydrogen sulfide exceeds that of oxygen). The reaction can be represented as:

Fe₂O₃(rust)+3H₂S→2FeS+3H₂O+S

These conditions commonly exist in closed, oil-processing equipment made from carbon steel and used to refine high-sulfur-containing feedstock. The individual crystals of pyrophoric iron sulfides are extremely finely divided, the result of which is that they have an enormous surface area-to-volume ratio.

When the iron sulfide crystal is subsequently exposed to air, it is oxidized back to iron oxide and either free sulfur or sulfur dioxide gas is formed. This reaction between iron sulfide and oxygen is accompanied by the generation of a considerable amount of heat. This rapid exothermic oxidation is known as pyrophoric oxidation and the heat it produces can ignite nearby flammable hydrocarbon-air mixtures. The reaction can generally be described by the following chemical equations:

4FeS+3O₂→2Fe₂O₃+4S₂+HEAT

4FeS+7O₂→2Fe₂O_{3b +4}SO₂+HEAT

This pyrophoric iron sulfide (PIS) lies dormant in the equipment until the equipment is shut down and opened for service, exposing the PIS to air, allowing the exothermic process of rapid oxidation of the sulfides to oxides to occur.

To combat the effects of pyrophoric reactions, the industry has, in the past, employed several standard procedures:

1. Acid cleaning with a corrosion inhibitor and hydrogen sulfide suppressant.

The acid dissolves sulfide scale and releases hydrogen sulfide gas. Cleaning/treating with an acid solution can be both effective and inexpensive. However, there are problems with this approach:
Disposal of the resulting hydrogen sulfide gas can be problematic.
The potential for corrosion can be great when the system contains more than one alloy.

2. Chelating solutions.

These are specially formulated, high-pH solutions that are effective at dissolving the sulfide deposits without emitting hydrogen sulfide. However, specially formulated chelation solutions for this application are costly.

3. Oxidizing chemicals.

Oxidizing chemicals convert the sulfide to oxide. Potassium permanganate (KMnO₄) has been commonly used in the past to oxidize pyrophoric sulfide. Potassium permanganate (or sodium permanganate) can be added to the equipment in combination with a water rinse, following a chemical cleaning procedure.

Another problem common to all of the existing methods is related to the nature of the equipment to be treated and the nature of the treatment solution. The pyrophoric material will form on all surfaces where hydrogen sulfide comes into contact with iron oxide. These surfaces can be (and typically are) vertical walls and the underside of horizontal features inside the equipment. Prior chemistries have been applied using steam to atomize or vaporize them so that once dispersed, they can contact all surfaces of the vessel. The problem with this method of application is that prior chemistries comprise simple mixtures of various constituents that tend to return to their constituent form when vaporized. Consequently, there can be no way to ensure that the proper ingredients are adequately applied.

Still another problem common to existing methods is the estimation and provisioning of an appropriate amount of chemical. Before vessels are opened to the atmosphere and inspected, there is no way to determine the amount of chemistry needed to treat them. As a result, either too much chemical is allocated (raising the cost of the project and producing an excessive amount of effluent), or insufficiently treating the pyrophoric material (potentially resulting in problematic combustion). The process of the present invention solves this problem inasmuch as an on-site ozone generator can make available a virtually limitless source of ozonated water to force the reaction to a satisfactory completion.

BRIEF SUMMARY OF THE INVENTION

Conversion of iron sulfide (FeS) to iron oxide (Fe₂O₃) occurs naturally as oxygen combines with the iron sulfide. Problems arise when the iron sulfide resides in the proximity of a sufficient quantity of oxygen in the presence of a combustible material. The process of the invention utilizes ozonated water as both an oxidizing agent and heat sink for the conversion of pyrophoric iron sulfide to iron oxide in iron sulfide-contaminated equipment.

The controlled oxidation of PIS is most often performed with a liquid product, such as a permanganate, because it absorbs heat and pyrophoric material that is covered with water/fluid/sludge would not likely be contacted with a vapor-phase product. The only way to treat this pyrophoric material quickly is to use water containing an oxidizing agent or use a liquid oxidizer. The most frequent oxidizing chemicals used to treat PIS-contaminated oil refining equipment are salts in a water solution. The present invention provides an alternative liquid oxidizing mechanism that uses an ozone generator to create ozonated water. An ozonated water treatment according to the invention may be applied in a manner similar to the methods used to inject the liquid-phase oxidizing chemicals of the prior art. The process of the invention solves the cost, effectiveness and effluent problems inherent in existing processes.

### BRIEF DESCRIPTION OF THE SEVERAL VIEWS OF THE DRAWING(S)

FIG. 1 is a schematic diagram of a generic process tower and certain ancillary equipment of the type to which the method of the invention is particularly applicable.

### DETAILED DESCRIPTION OF THE INVENTION

Any of several methods may be used to generate and apply the ozonated water used in the process of the invention. Ozone generators which output ozonated water are commercially available. One such device is described in U.S. Pat. No. 6,153,151 to Moxley et al. and entitled “System and method for generating ozonated water.”

After the process equipment is taken out of service and chemically cleaned of hydrocarbons, the entire system may remain oxygen-free. This may be accomplished by leaving the system under positive pressure with either deaerated steam or nitrogen purging through the equipment.

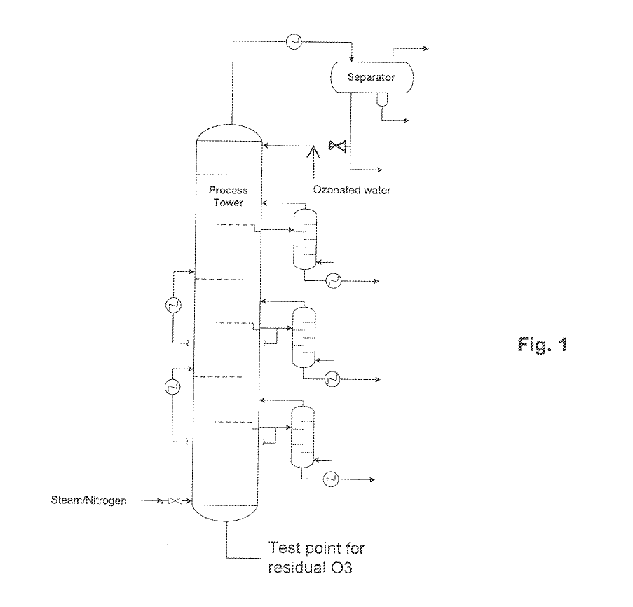

At this point, the steam may be shut off and the equipment may be put under a nitrogen purge or opened to the atmosphere. Then, the equipment may be rinsed with water to remove any residual oil or cleaning chemicals. After the water rinse, additional water may be put through an ozone generator and pushed into the line that delivered the former rinse water (often a reflux control valve). After a period of time, the line will fill with ozonated water. This ozonated water may be pushed into the system with a continual stream of ozonated water, or it may be pushed in with non-ozonated water (if larger flow rates are desired). Residual ozone levels in the water may be measured at the low point drains (see FIG. 1) using one of several methods commercially available. An ozone concentration sensor is described in U.S. Pat. No. 7,502,114 to Levine et al.

When significant residual ozone is observed at the low point drains, the pyrophoric material has been rendered harmless, and the process may be considered complete and the system may be opened for maintenance.

An example of an ozonated water oxidation process according to one particular embodiment of the invention comprises the following steps:

1. The equipment to be cleaned is de-inventoried of liquids;

2. A process such as that described in U.S. Pat. No. 6,893,509 to Sears et al. and entitled “Method of cleaning vessels in a refinery” (the entire contents of which is hereby incorporated by reference) or another suitable cleaning method is used to remove hydrocarbons and other contaminants from the equipment;

3. The system is left under a steam dwell to purge the remaining gases and cleaning products;

4. Nitrogen is introduced into the system—e.g., using a pressurized plant nitrogen supply (see valved “Nitrogen” inlet in FIG. 1);

5. The steam is shut off and the system is allowed to begin drying and reaching equilibrium;

6. The system is blocked away from the flare and effluent system and vented to atmosphere at a high point vent at the end of the circuit near the vent to flare points such as an overhead accumulator;

7. Equipment with trays and other internals that may hold liquids are rinsed batch-wise with water by injecting water into the reflux control valve;

8. Step 7 is repeated as needed until the majority of hydrocarbons are removed as indicated by the effluent water quality at the low point drains;

9. The ozone generator is turned on and water is flowed through it and into the system at the reflux control valve (which may be the same one that was utilized for the initial water rinse);

10. After a predetermined amount of time (based on the size of the equipment and the capacity of the ozone generator), the main water rinse source is turned on to push the ozonated water into the equipment for a batch rinse;

11. Low point drains are tested for residual ozone using ozone test strips or an ozone sensor;

12. If the residual ozone is lower than the desired concentration, step 10 is repeated, as necessary;

13. Once the desired residual ozone concentration is achieved, the ozone generator is shut off and all water is drained from the equipment; and,

14. The equipment is then opened to permit access for maintenance activities.

The foregoing presents particular embodiments of a system embodying the principles of the invention. Those skilled in the art will be able to devise alternatives and variations which, even if not explicitly disclosed herein, embody those principles and are thus within the invention's spirit and scope. Although particular embodiments of the present invention have been shown and described, they are not intended to limit what this patent covers. One skilled in the art will understand that various changes and modifications may be made without departing from the scope of the present invention as literally and equivalently covered by the following claims.

What is claimed is:

1. A method for treating equipment for pyrophoric iron sulfide contamination comprising:
substantially filling the equipment with ozonated water;
waiting a period of time; and then,
rinsing the equipment with water.

2. The method recited in claim 1 wherein the length of the period of time is determined by testing the water fill for residual ozone.

3. The method recited in claim 1 further comprising substantially removing any hydrocarbons from the equipment prior to filling the equipment with the ozonated water.

4. The method recited in claim 3 wherein the hydrocarbons are removed by injecting a formulation comprising a non-aqueous, monocyclic, saturated terpene mixed with at least one non-ionic surfactant using high-pressure steam to form a cleaning vapor.

5. The method recited in claim 1 further comprising applying nitrogen to the equipment to maintain a positive pressure between about 5 and about 10 pounds per square inch prior to filling the equipment with the ozonated water.

6. The method recited in claim 1 further comprising rinsing internal features within the equipment that could hold liquids with water prior to filling the equipment with the ozonated water.

7. The method recited in claim 3 further comprising applying a steam dwell to the equipment to purge remaining gases and any cleaning products.

8. The method recited in claim 7 further comprising introducing nitrogen gas into the system.

9. The method recited in claim 8 further comprising shutting off the steam dwell and allowing the equipment to equilibrate.

10. The method recited in claim 1 further comprising rinsing trays and other equipment internals batch-wise with water.

11. The method recited in claim 10 wherein the water is injected into a reflux control valve.

12. The method recited in claim 10 further comprising repeatedly rinsing trays and other equipment internals batch-wise with ozonated water until effluent water quality reaches a predetermined level.

13. The method recited in claim 1 wherein the ozonated water is introduced into the equipment at a reflux control valve.

14. The method recited in claim 1 wherein the period of time is determined based on the size of the equipment and the capacity of an ozone generator used to produce the ozonated water.

15. The method recited in claim 1 further comprising sampling the water fill and testing the samples for residual ozone.

16. The method recited in claim 15 wherein testing the samples for residual ozone comprises testing with colorimetric test strips.

17. The method recited in claim 15 further comprising shutting off an ozone generator used to produce the ozonated water and draining the water from the equipment when a predetermined residual ozone concentration is achieved.
